(19) United States
(12) Patent Application Publication
(10) Pub. No.: US 2005/0060309 A1
(43) Pub. Date: Mar. 17, 2005

(54) Query objects

(76) Inventor: Oliver Scheerer, Walldorf (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/942,149

(22) Filed: Sep. 15, 2004

Related U.S. Application Data
(60) Provisional application No. 60/503,249, filed on Sep. 15, 2003.

(51) Int. Cl. G06F 7/00

(52) U.S. Cl. 707/5

(57) ABSTRACT

Methods and apparatus, including computer program products, for providing a query object. In one general aspect, a query object includes an attribute uniquely identifying the business object. The query object includes an interface that includes at least a service that provides, to a calling application, information that specify a group of one or more instances of one ore more business objects. A calling application uses the information to address the group of one or more instances of one or more business objects, on which the application can perform one or more functions.

### CROSS-REFERENCE TO RELATED APPLICATIONS

This application claims priority based on U.S. patent application Ser. No. 60/503,249 for Method and System for Query Objects Usage in Data Management, filed Sep. 15, 2003, the disclosure of which is incorporated here by reference in its entirety.

### BACKGROUND

The present specification relates to data processing and data objects.

Data objects are elements for information storage in object-oriented computing systems. Data objects can describe the characteristics of an item using a series of data fields that, for example, can correspond to described characteristics. Typically, a programmer will predefine a collection of standard object classes, referred to in the present specification as object types, that are hardcoded into a set of machine-readable instructions for performing operations. Object types are blueprints for describing individual objects using a defined set of class attributes (or properties). Instantiated objects that are members of such standard object types can be applied in a variety of different data processing activities by users, for example, customers who are largely unaware of the structure of the standard object types.

One example of a data object is a business object, which is typically used in data processing to describe the characteristics of an item or a process related to the operations of an enterprise. A business object can represent, by way of example, a document, a sales order, a product, a piece of manufacturing equipment, an employee, and even the enterprise itself.

A business object usually includes multiple layers, at the core of which is a kernel that represents the object's data. Also typically included is an interface layer that, among other things, defines an interface consisting of a set of clearly defined methods, which are said to be associated with the business object. Such methods, also referred to as services, can be one or more data processing operations, for example, one that reads, writes, or deletes data during run time from the kernel of the business object.

As with other data objects, business objects may be of a particular type. In conventional systems, one must usually define services for each business object type, and the interface layer for a particular type of business objects is typically specific to and is compatible with only the individual business objects of that type.

The data of a business object is typically only accessible by invoking one of its associated services. The application invoking the service will be referred to in the present specification as a calling application. When executing a service of a business object, the calling application can change the object's data, i.e., the object's state.

An application can generally perform one or more functions implementing any business processes, which are processes performed by an enterprise during the course of business. Examples of business processes include and are not limited to a process that distributes a business object from one node of a network to another node of the network, a process that provides a bill of material for a business object, and a process that calculates costs associated with an item represented by a business object.

Frequently, an application addresses, i.e., applies one or more of its functions, to more than one business object. The above-described distribution process, for example, typically distributes more than one business object. Such applications, in conventional systems, typically include code that defines the particular group of business object instances to which the business process is applied. That is, such applications include code defining a grouping mechanism. The calling application that distributes business objects, for example, can include code that specify an attribute common to the business object instances of the group to be distributed or, alternatively, a particular business object type, i.e., class, to which the business object instances of the group belongs.

### SUMMARY

The present invention provides methods and apparatus, including computer program products, that implement techniques for providing a query object, which is a data object that includes a mechanism for defining a group of one or more business object instances. The grouping can be arbitrary and freely definable.

In one implementation, the query object is a business object that includes an interface that includes a service. The service provides, to a calling application, information specifying a particular group of one or more business object instances. That is, the information specifies one or more instances of one or more business objects. The calling application can use the information provided by the query object to address the group of one or more instances of one or more business objects and, thus, need not include code defining the grouping mechanism for the particular group.

In one general aspect, the techniques feature a computer program product for performing one or more functions. The product includes instructions operable to cause data processing apparatus to receive information specifying an instance of a data object. The instance of the data object is associated with at least a service that provides, to a calling application, information that specify one or more instances of one or more other data objects. The product includes instructions to call the service associated with the instance of a data object and receive the information provided by the service. The product includes instructions to execute one or more functions on the group of one or more instances of one or more data objects specified by the information. The product is tangibly stored on machine-readable medium.

In another general aspect, the techniques feature a computer-implemented method that includes receiving information specifying an instance of a query object. The instance of the query object includes an interface having at least a service that provides, to a calling application, information that specify a group of one or more instances of business objects. The method includes receiving information specifying an application having one or more functions. The method includes causing the application to call the service and receive information specifying the group of one or more instances of business objects. The method includes causing the application to perform the one or more functions on the group of one or more instances of business objects.

In another general aspect, the techniques feature a business object that includes an attribute uniquely identifying the business object. The business object includes an interface that includes at least a service that provides, to a calling application, information that specify a group of one or more instances of one ore more business objects. The calling application uses the information to address the group of one or more instances of one or more business objects, on which the application can perform one or more functions.

In another general aspect, the techniques feature a computer program product for providing a query object. The product includes instructions to cause a processor to receive input specifying an arbitrary grouping of one or more instances of one or more business objects and store information specifying the arbitrary grouping. The product includes instructions to execute, in response to receiving, from a calling application, a request for the information, a service that provides the information to the calling application. The calling application can use the information to address the group and perform one or more functions on the group. The product is tangibly stored on machine-readable medium,

In another general aspect, the techniques feature a computer-implemented method that includes accessing a query object that includes information defining a group of one or more instances of business objects. The method includes using the information to select the group of one or more instances of business objects. The method includes applying a business process to the selected group of instances of business objects.

The invention can be implemented to realize one or more of the following advantages. With a data processing system in which applications can access the above-described grouping information from query objects, it is not necessary to change the code of each of the applications each time a grouping mechanism is introduced in order for the applications to address the group of data object instances defined by the new grouping mechanism (as would be required in conventional systems). The only necessary task is to define a query object that includes information specifying the grouping mechanism. As there can be numerous applications in the system, each of which requiring reprogramming whenever a new grouping mechanism is introduced, using a query object can save a significant amount of programming resources.

When a new application is introduced to the system, it is not necessary to include in the code of the new application a grouping mechanism. All that is required to ensure that the new application can address groups of data object instances is to include, in the code of the new application, instructions needed to access grouping information from query objects, which is typically relatively much simpler than coding a grouping mechanism in the application.

As frameworks for generating data objects, for example, business object repositories, can be used to generate query objects, using a query object to introduce a new grouping mechanism can generally be relatively simple compared to reprogramming each of the applications in a data processing system of an enterprise. One implementation of the invention provides all of the above advantages.

Details of one or more implementations of the invention are set forth in the accompanying drawings and in the description below. Further features, aspects, and advantages of the invention will become apparent from the description, the drawings, and the claims.

### BRIEF DESCRIPTION OF THE DRAWINGS

FIG. 1 is a block diagram of a query object.

FIG. 2 is a block diagram of an implementation of a query object.

FIG. 3 is a flowchart illustrating a process for defining a query object.

FIG. 4 is a flowchart illustrating, from a user perspective, a process for defining a query object that is a business object.

FIG. 5 is a flowchart illustrating, from the perspective of a framework, a process for defining a query object that is a business object.

FIG. 6 is a flowchart illustrating, from the perspective of the framework, a process for generating a query object that is a business object.

FIG. 7 is a flowchart illustrating a process in which a calling application uses a query object to address a group of one or more data object instances.

FIG. 8 is a flowchart illustrating a process in which a new grouping mechanism is implemented.

FIG. 9 is a flowchart illustrating a process in which a new application that can address multiple data objects is implemented.

FIG. 10 shows a system in which query objects can be implemented.

Like reference numbers and designations in the various drawings indicate like elements.

### DETAILED DESCRIPTION

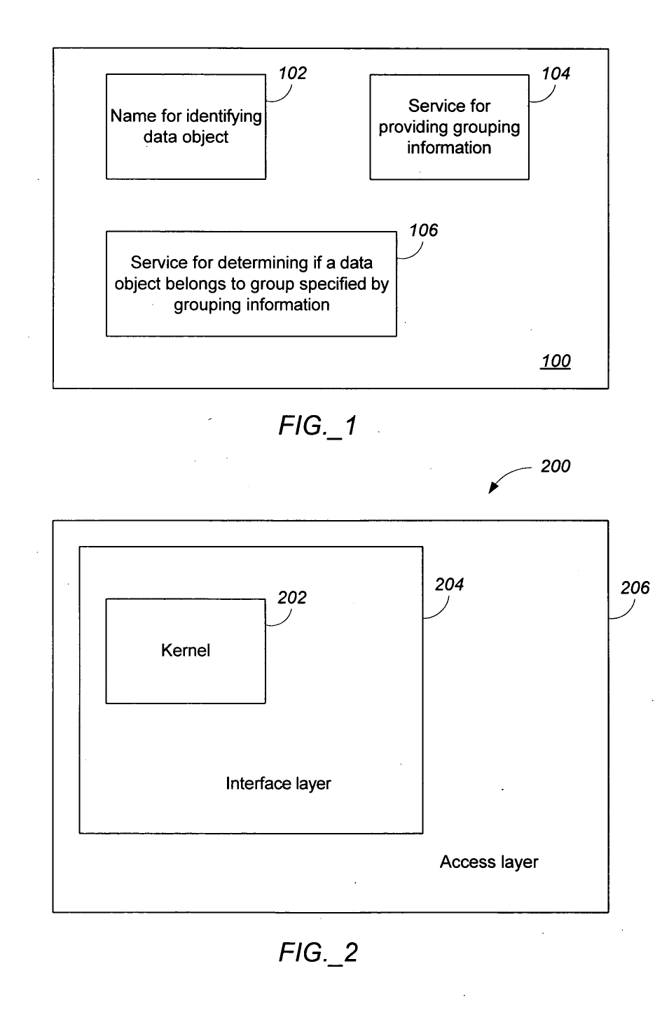

FIG. 1 shows a block diagram of a query object 100. The query object 100 is a data object and includes at least two attributes—a name 102 for identifying the query object and a service 104 for providing grouping information. The name 102 can be a string of characters, for example, a descriptive name such as “ALL_SIMPLE_BOMS” or “ALL_DOCUMENTS.” The name 102 can be unique and used as a key to identify the data object 100.

The service 104 includes one or more grouping mechanisms, i.e., the logic for grouping one or more business object instances. The grouping mechanism can be freely definable and can group an arbitrary one or more data object instances. The grouping mechanism can group, for example, all data objects that represent documents and data objects that represent products and that satisfy some criteria. The service 104 uses the grouping mechanism to provide grouping information, i.e., information specifying one or more data object instances, in response to a request from a calling application. The service 104 can be implemented by selection and/or query commands.

Optionally, the query object 100 includes a service 106 that, given a particular data object instance, determines whether the data object instance belongs to the group specified by the grouping information. Like the service 104, the service 106 can be implemented by selection and/or query commands. Another optional service is one that retrieves and delivers the data objects instances to the calling application.

The above-described services of the query object 100 are generic in the sense that they are not specific to any particular grouping information. They include code that provides one or more mechanisms for arbitrarily grouping one or more data object instances. However, the code is not specific to particular business object instances. For example, the code can specify attributes to be used for grouping but does not include the attribute values to define a particular selection range of data object instances. The services are customized, i.e., become specific to particular grouping information (for example, by having particular attribute values), when the query object is instantiated. Query object instances, thus, have customized service whereas query objects have generic services.

FIG. 2 is a block diagram of a business object 200, which is an implementation of the query object 100. The business object 200 includes a kernel that contains the data of the business object. This data includes attribute data, for example, the above described query object name and attribute values.

The business object 200 includes an interface layer 204 that includes the above-described two services. The interface layer 204 is implemented as an ABAP class. The interface 204 need not be limited to an ABAP class implementation but, rather, can be implemented by any object-oriented programming language. The two services are called getObjects and hasObjects. The getObjects service retrieves and provides to a calling application keys of business object instances included in the group specified by the grouping information of the business object 200. The hasObjects service, given a particular business object instance, checks whether the particular business object instance belongs to the group specified by the grouping information of the business object 200. Optionally, the interface layer can include other services, for example, one that allows a user to set or change attribute values and, thus, change a grouping.

The business object 200 includes an access layer 206, which defines the technologies that can be used to obtain external access to the object's internal data. Such technologies can include, for example, COM/DCOM (Component Object Model/Distributed Component Object Model).

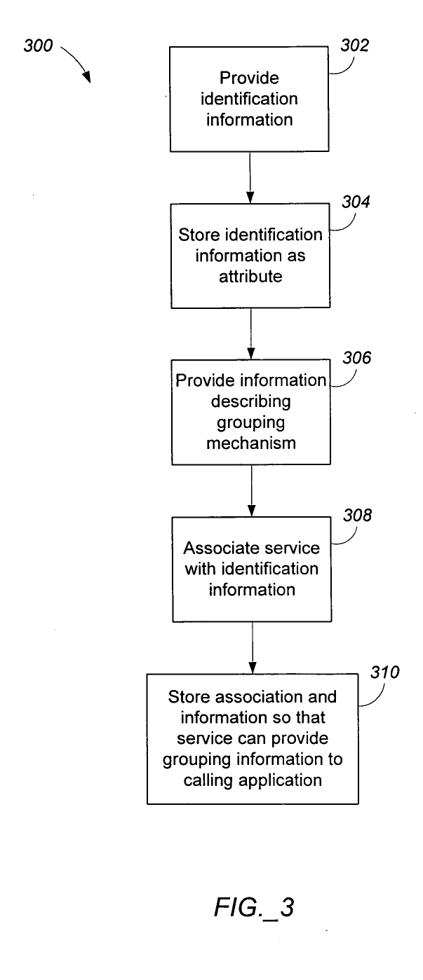

FIG. 3 is a flowchart illustrating a process 300 for generating a query object. A user provides identification information (step 302). The identification information can include a name for the query object, which name can include any combination of characters. A data processing system of an enterprise stores the identification information as an attribute of the query object (step 304). The user provides information describing one or more grouping mechanism (step 306). As indicated above, the grouping can be arbitrary and freely definable. The user can provide the information by, for example, including it in the program code of the service. Alternatively, the user can adapt a pre-defined set of code or provide declarative statements to a framework that will automatically generate the necessary code defining the grouping mechanism, as will be described below. The system associates the identification information with information describing one or more grouping mechanism (step 308). That is, the system connects the identification of the query object with the grouping mechanisms provided by the user and thus creates a query object. The system stores the association and the information describing the one or more grouping mechanism (step 310). That is, the system stores the query object created. The query object is stored so that a service of the query object can provide grouping information in response to a request from a calling application for such information.

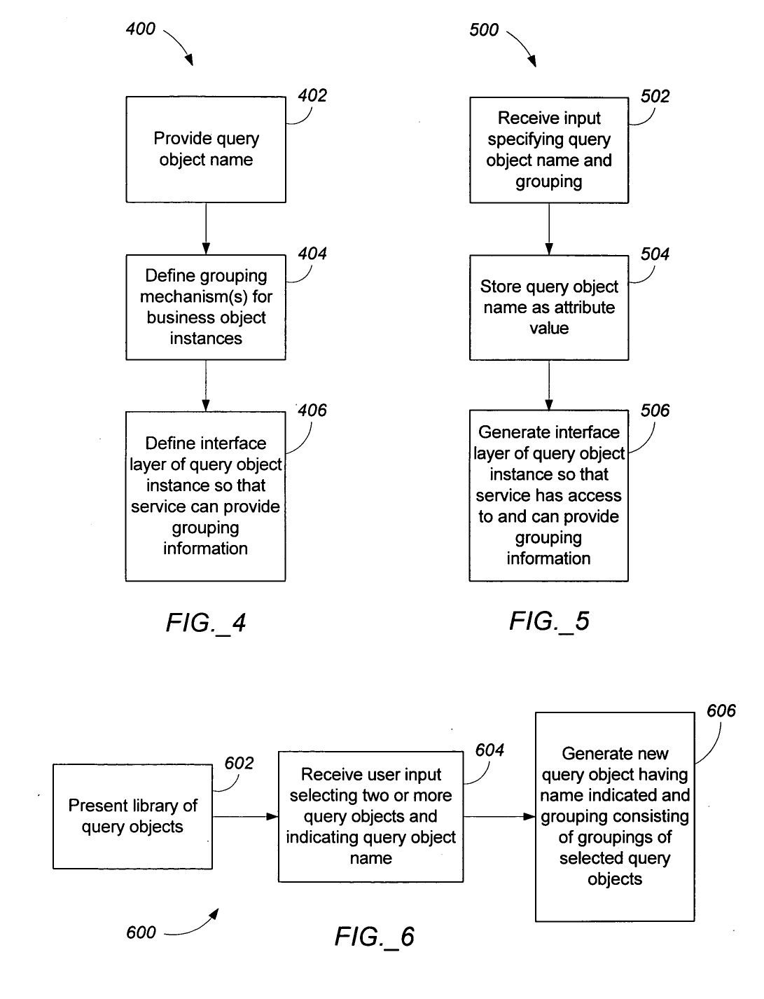

FIG. 4 is a flowchart illustrating, from a user perspective, a process 400 for generating a query object that is a business object. A user provides to a data processing system a query object name (step 402). The system can include a user interface for exchanging information with the user. The interface can be, for example, a framework such as a business object repository (BOR) provided by SAP AG of Walldorf, Germany. As indicated above, the name can be a string of any characters.

The user defines one or more grouping mechanism for business object instances (step 404). As indicated above, the grouping mechanism can be arbitrary and can group business objects instances in any way. For example, the grouping can group all instances of a first business object and a particular range of instances of a second business object.

The user defines the interface layer of the query object so that a service of the interface can provide grouping information according to the grouping mechanism (step 406). Typically, the system provides, through the above-described user interface, the user with a definition of the interface layer of the query object (for example, the interface layer 204 of FIG. 2). The user then defines and implements the interface layer, for example, by creating an ABAP class that incorporates the above described getObjects and hasObjects services, as well as the grouping mechanism defined by the user. The resulting query object can be used by calling application to obtain grouping information.

FIG. 5 is a flowchart illustrating, from the perspective of a framework, a process 500 for generating a query object that is a business object. The framework includes logic that automatically generates a query object when given information specifying a query object name, one or more grouping mechanism, and selection criteria (for example, attribute values). The framework can be the above-described business object repository, which can include one or more user interfaces for generating query objects. The framework receives user input that includes the described information (step 502). The input can be received through a graphical user interface for exchanging information with the user. The input can be implemented as declarative statements or completion of table with the appropriate information. The framework stores the query object name as an attribute value (step 504). The logical storage location is the kernel of the query object being defined. The framework generates the interface layer for the query object being defined (step 506). The interface layer includes the getObjects and hasObjects services and, furthermore, incorporates the grouping mechanism and attribute values provided by the user so that the getObjects service can provide grouping information to a calling application. The query object generation can be automatic, i.e., not require user input in addition to those described above.

FIG. 6 is a flowchart illustrating, from the perspective of the framework, a process 600 for generating a query object that is a business object. The framework presents a library of query objects (step 602). The query objects in the library can be pre-defined. Examples of pre-defined query objects include and are not limited to query objects that groups all business partners of an enterprise, all documents in a data processing system of the enterprise, all products of the enterprise, and bills of materials of the enterprise. The presentation can be effect through a graphical user interface. The presentation can include information describing the grouping mechanism of each query object.

The framework receives user input selecting two or more query objects from the library and, furthermore, indicating a name for the query object being defined (step 604). The selection can be effected by the user dragging and dropping the query objects of interests into a window designated for defining new query objects.

The framework generates a new query object (step 606). The new query object has the name provided by the user. The new query object groups together the groups of the query objects selected by the user. In a sense, the new query objects is a combination of the selected query objects, and the grouping mechanism of the new query object is a combination of the grouping mechanisms of the selected query objects.

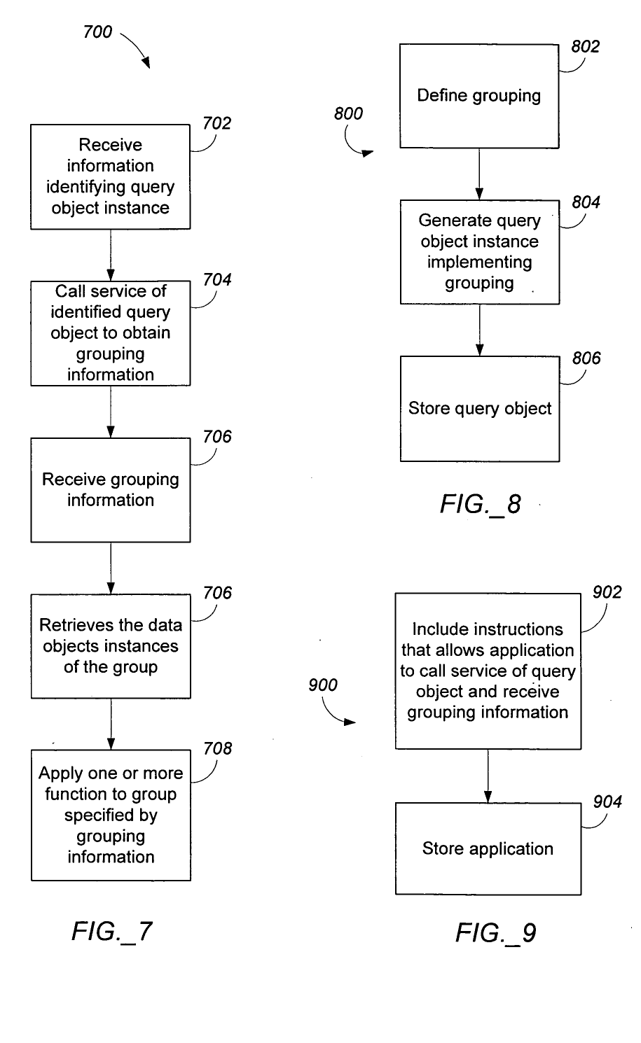

FIG. 7 is a flowchart illustrating a process 700 in which an application uses a query object to address a group of one or more data object instances. The application receives information identifying a query object instance (step 702). The information can include a name that is unique to the query object instance and a network location of the query object instance. The application calls the service of the query object instance that provides grouping information (step 704). The service can be, for example, the getObjects service described above. In response, the query object service provides to the calling application the requested grouping information, which the application receives (step 706). The calling application retrieves the business object instances specified by the grouping information (step 708). The calling application applies one or more functions to the data object instances retrieved (step 710). As discussed above, the one or more functions can implement one or more business processes, including distributing, from one node of a network to another node of the network, data object instances that represent master data.

FIG. 8 is a flowchart illustrating a process 800 in which a new grouping mechanism is implemented in a data processing system of an enterprise. A user defines a grouping of data objects instances that, as indicated above, can be arbitrary (step 802). The user generates a query object that implements the grouping (step 804). The user can perform one of the above-described processes to generate the query object. The interface layer of the query object complies with requirements to allow applications of the system to call services of the query object. The user stores the query object in the system (step 806). The query object is stored at a memory location where it is accessible to applications of the system.

FIG. 9 is a flowchart illustrating a process 900 in which a new application that can address multiple data objects is implemented. A user, typically a programmer, includes code in the new application that allows the application to call services of query objects (step 902). Note that such programming needs to be performed only once, after which the application can call any available query object and, thus, use any available grouping mechanism. Optionally, the user can use a template to generate the required code. The user then stores the application in a memory of a data processing system of an enterprise (step 904).

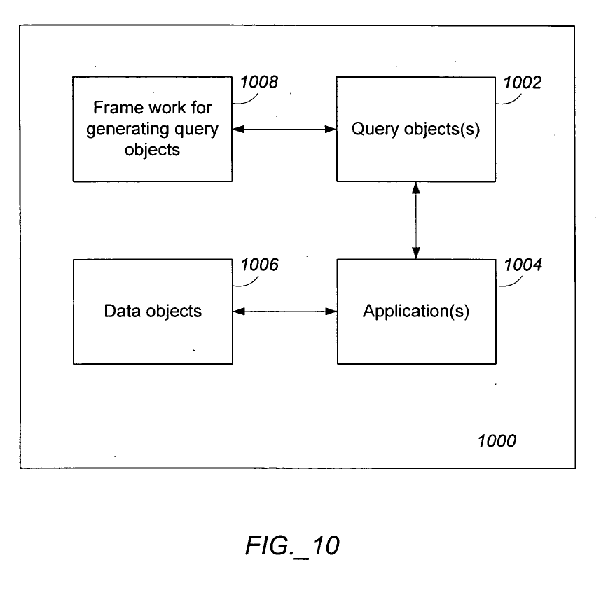

FIG. 10 shows a system 1000 in which query objects can be implemented. The system 1000 includes one or more query objects 1002, one or more applications 1004, one or more data objects 1006, and a framework 1008 for generating query objects. The links between these components can be, for example, a data bus, a network, or a combination of both. The system can generate query objects, as described above, in a design stage. At run time, the system 1000 can instantiate the query objects, and an application can call on the services of a query object to obtain grouping information. The application can then address the data object instances specified by the grouping information. In one implementation, the system 1000 is implemented in MDM Version 2.0, available from SAP AG. MDM, also referred to as Master Data Management, is an application that allows the management of master data in a heterogeneous computing landscape.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component (e.g., a data server), a middleware component (e.g., an application server), or a front-end component (e.g., a client computer having a graphical user interface or a Web browser through which a user can interact with an implementation of the invention), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments, but other embodiments can be implemented and are within the scope of the following claims. For example, the operations of the invention can be performed in a different order and still achieve desirable results. In certain implementations, multitasking and parallel processing may be preferable. Other embodiments are within the scope of the following claims

1. A computer program product, tangibly stored on machine-readable medium, for performing one or more functions, the product comprising instructions operable to cause data processing apparatus to:
receive information specifying an instance of a data object, the instance of the data object being associated with at least a service that provides, to a calling application, information that specify one or more instances of one or more other data objects;
call the service associated with the instance of a data object and receive the information provided by the service; and
execute one or more functions on the group of one or more instances of one or more data objects specified by the information.

2. The product of claim 1, further comprising instructions to:
given information specifying a particular instance of a data object, determine whether the particular instance of the data object is the same as any one of the one or more instances of one or more data objects specified by the service.

3. The product of claim 1, wherein the instance of the data object is a first instance of the data object, the product further comprising instructions to:
receive information specifying a second instance of the data object, the second instance of the data object being associated with at least a service that provides, to a calling application, information that specify one or more instances of one or more other data objects, at least one of which instances is different from the instances specified by the service associated with the first instance of the data object;
without needing a change of instructions of the compute program product, call the service associated with the second instance of the data object and receive the information provided by the service; and
execute the one or more functions on the one or more instances of the one or more data objects specified by the information.

4. The product of claim 1, further comprising instructions to:
call the service of any instances of any query objects, whereby instructions specifying instances of business objects do not need to be included in the instructions of the product.

5. The product of claim 1, wherein:
one or more instances of one or more data objects are specified in accordance with user input.

6. The product of claim 1, wherein:
the one or more functions implement one or more business processes.

7. The product of claim 1, wherein:
the one or more functions include one of a function that provides a cost of an item represented by an instance of a data object and a function that distributes instances of data objects from one node of a network to another node of the network.

8. The product of claim 1, wherein:
the data objects are business objects.

9. A computer-implemented method comprising:
receiving information specifying an instance of a query object, the instance of the query object including an interface having at least a service that provides, to a calling application, information that specify a group of one or more instances of business objects;
receiving information specifying an application having one or more functions;
causing the application to call the service and receive information specifying the group of one or more instances of business objects; and
causing the application to perform the one or more functions on the group of one or more instances of business objects.

10. The method of claim 9, further comprising:
given information specifying a particular instance of a business object, determine whether the particular instance of the business object belongs to the group.

11. The method of claim 9, wherein the instance of the query object is a first instance and the group is a first group, the method further comprising:
receiving information specifying a second instance of the query object, the second instance of the query object including an interface having at least a service that provides, to a calling application, information that specify a second group of one or more instances of one or more other business objects, at least one of which instances is different from the instances of the first group;
without needing a change of instructions of the compute program product, calling the service associated with the second instance of the query object and receiving the information provided by the service; and
performing the one or more functions on the instances of the second group.

12. The method of claim 9, wherein performing one or more functions include:
performing a function that implements a business process.

13. The method of claim 9, wherein performing one or more functions include one of:
calculating a cost of an item represented by an instance of a business object and distributing instances of business object from one node of a network to another node of the network.

14. The method of claim 9, further comprising:
defining the service so that information provided to a calling application specify a group of one or more instances in accordance with user input.

15. A business object, comprising:
an attribute uniquely identifying the business object; and
an interface that includes at least a service that provides, to a calling application, information that specify a group of one or more instances of one ore more business objects, wherein the calling application uses the information to address the group of one or more instances of one or more business objects, on which the application can perform one or more functions.

16. The business object of claim 15, wherein:
the interface includes another service that, given a particular instance of a business object, determines whether the particular instance belongs to the group.

17. The business object of claim 15, wherein:
the one or more functions implement one or more business process.

18. The business object of claim 15, wherein the one or more functions include one of:
a function that distributes instances of business objects from one node of a network to another node of a network; and
a function that provides a cost of an item represented by an instance of a data object.

19. A computer program product, tangibly stored on machine readable medium, for providing a query object, the product comprising instructions to cause a processor to:
receive input specifying an arbitrary grouping of one or more instances of one or more business objects and store information specifying the arbitrary grouping;
in response to receiving, from a calling application, a request for the information, execute a service that provides the information to the calling application, wherein the calling application can use the information to address the group and perform one or more functions on the group.

20. The product of claim 19, further comprising instructions to:
in response to receiving a request that includes information specifying a particular instance of a business object, execute a service that determines whether the particular instance of a business object belongs to the group.

21. The product of claim 19, wherein:
the one or more functions include a function that distributes instances of business objects from a node of a network to multiple nodes of the network.

22. A computer-implemented method, comprising:
accessing a query object that includes information defining a group of one or more instances of business objects;
using the information to select the group of one or more instances of business objects; and
applying a business process to the selected group of instances of business objects.
